(19) United States
(12) Patent Application Publication
(10) Pub. No.: US 2026/0359382 A1
(43) Pub. Date: Nov. 12, 2026

(54) EXTRACTING NODES VIA ALPHA CENTRALITY WITH MULTIPLE DAMPING FACTORS

(71) Applicant: International Business Machines Corporation, Armonk, NY (US)

(72) Inventors: Vasileios Kalantzis, Nyack, NY (US); Lior Horesh, North Salem, NY (US); Shashanka Ubaru, Austin, TX (US); Georgios Kollias, White Plains, NY (US)

(21) Appl. No.: 19/199,932

(22) Filed: May 6, 2025

(51) Int. Cl. G06F 17/16; G06F 17/17

(52) U.S. Cl. CPC G06F 17/16; G06F 17/17

(57) ABSTRACT

A system includes a processor that executes computer executable components stored in a memory. The computer executable components can comprise a graph construction component that builds an adjacency matrix A from raw network data; an exogenous influence component that generates an influence vector β by assigning values that reflect external factors influencing network nodes; a parameter control component that establishes key parameters; a Chebyshev polynomial generator component that iteratively computes polynomial terms; a coefficient calculation component that computes required Chebyshev coefficients αₖ for accurate weighting of each polynomial term; a resolvent approximation component that reconstructs inverse-like matrix behavior; an Alpha Centrality computation component that calculates node influence scores; and an analysis component that scales the computed scores and maps them back to node identities.

### BACKGROUND

The subject disclosure relates to node extraction, e.g., extracting the most important nodes of networks via alpha centrality with multiple damping factors.

Graphs are fundamental data structures used to model relationships among entities across diverse domains, such as web traffic, financial transactions, and social interactions. Within these networks, identifying the most central or influential nodes is a critical task in network analysis. Centrality measures serve this purpose by assigning scores to each node, which can then be used to rank their relative importance. Several well-established centrality metrics exist, including eigenvector centrality, subgraph centrality, and Katz centrality, each offering different perspectives on influence within a network.

Katz centrality, introduced by Leo Katz in 1953, extends beyond shortest-path metrics by accounting for all paths—direct and indirect—between nodes. This approach measures influence by summing the number of walks of all lengths from a given node, with longer walks attenuated by a damping factor. Mathematically, Katz centrality relies on evaluating a series. However, computing this inverse for multiple values of leads to significant computational burden, as it requires solving a sequence of linear systems, often via Krylov subspace iterative methods like MINRES.

As a result, while Katz centrality offers a rich and nuanced view of node influence, its practical adoption in large-scale or real-time applications is frequently limited by the associated computational overhead. This creates a strong need for more efficient approaches to approximate or accelerate Katz centrality computations without sacrificing analytical fidelity.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate most important node extraction via Katz centrality with multiple damping factors.

According to an embodiment, a system can comprise a processor that executes computer executable components stored in memory. The computer executable components can comprise a graph construction component that builds an adjacency matrix A from raw network data. The computer executable components can further comprise an exogenous influence component that generates an influence vector β by assigning values that reflect external factors influencing network nodes. The computer executable components can further comprise a parameter control component that establishes key parameters. The computer executable components can further comprise a Chebyshev polynomial generator component that iteratively computes polynomial terms. The computer executable components can further comprise a coefficient calculation component that computes required Chebyshev coefficients αₖ for accurate weighting of each polynomial term. The computer executable components can further comprise a resolvent approximation component that reconstructs inverse-like matrix behavior. The computer executable components can further comprise an Alpha Centrality computation component that calculates node influence scores. The computer executable components can further comprise an analysis component that scales the computed scores and maps them back to node identities.

According to another embodiment, a computer-implemented method can comprise building, by a system operatively coupled to a processor, an adjacency matrix A from raw network data. The computer-implemented method can comprise generating, by the system, an influence vector β by assigning values that reflect external factors influencing network nodes. The computer-implemented method can further comprise establishing, by the system, key parameters. The computer implemented method can further comprise iteratively computing, by the system, polynomial terms. The computer implemented method can further comprise computing, by the system, required Chebyshev coefficients αₖ for accurate weighting of each polynomial term. The computer implemented method can further comprise reconstructing, by the system, inverse-like matrix behavior. The computer implemented method can further comprise calculating, by the system, node influence scores. The computer implemented method can further comprise scaling, by the system, the computed scores and mapping them back to node identities.

According to another embodiment, a computer program product can comprise a computer readable storage medium having program instructions embodied therewith. The program instructions can be executable by a processor to cause the processor to generate, by the processor, an influence vector β by assigning values that reflect external factors influencing network nodes. The program instructions can also cause the processor to establish key parameters. The program instructions can also cause the processor to iteratively compute, by the processor, polynomial terms. The program instructions can also cause the processor to compute, by the processor, required Chebyshev coefficients αₖ for accurate weighting of each polynomial term. The program instructions can also cause the processor to reconstruct, by the processor, inverse-like matrix behavior. The program instructions can also cause the processor to calculate, by the processor, node influence scores. The program instructions can also cause the processor to scale, by the processor, the computed scores and map them back to node identities.

### BRIEF DESCRIPTION OF THE DRAWINGS

FIG. 1 illustrates an example system that can facilitate most important node extraction via Alpha centrality with multiple damping factors in accordance with some embodiments described herein.

FIG. 2 illustrates a flow diagram of an example computer implemented method that can facilitate most important node extraction via Alpha centrality with multiple damping factors in accordance with some embodiments described herein.

FIG. 3 illustrates an example of a graph structure used to represent influence relationships in accordance with some embodiments described herein.

FIGS. 4 and 5 illustrate results of an example use case demonstrating the effectiveness of most important node extraction via Alpha centrality with multiple damping factors in accordance with some embodiments described herein.

FIG. 6 illustrates a block diagram of an example computing environment in which some embodiments described herein can be facilitated.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

Graphs are foundational structures used to model and analyze relationships among entities in diverse domains, including social networks, web connectivity, biological systems, and financial transactions. Within these networks, a fundamental challenge is to determine the most influential nodes—those that play a critical role in propagating information, driving dynamics, or maintaining structural coherence. Centrality metrics are mathematical tools used to quantify such influence by assigning importance scores to nodes. Among the available metrics, Alpha Centrality and its related variants, such as Katz centrality, are particularly notable because they incorporate not only direct connections (immediate neighbors) but also indirect influences that propagate across longer paths in the network. These measures are computed by summing weighted walks of varying lengths starting from each node, with weights decreasing for longer walks based on a user-defined damping parameter α.

Katz centrality, a well-known form of Alpha Centrality, is defined through the matrix expression x=(I−αA)⁻¹1, where A is the adjacency matrix of the graph, α is a scalar in the interval (0,1/∥A∥₂), and 1 is a vector of ones. This expression captures the accumulated influence of a node across all possible walks in the network, with longer walks attenuated exponentially. However, computing this inverse directly is computationally expensive, particularly when a robust analysis requires evaluation across multiple α values near the convergence boundary. Solving the corresponding linear systems (I−αA)x=1 repeatedly using Krylov subspace iterative solvers such as MINRES becomes infeasible for large-scale graphs or real-time applications. The computational burden increases significantly with graph size and with the number of evaluations required for different a or external influence configurations.

The disclosed system addresses this challenge by introducing a framework that approximates the inverse-like behavior of the resolvent (I−αA)⁻¹ through a weighted combination of simpler matrix inverses. The system employs Chebyshev polynomial techniques and rational approximations to construct an efficient surrogate matrix Mα≈(I−αA)⁻¹, allowing rapid computation of centrality scores. A graph construction component first builds an adjacency matrix from raw network data. An exogenous influence component then generates a vector β reflecting external or contextual factors, which may vary over time or application domain. A Chebyshev polynomial generator iteratively computes basis terms using recurrence relations, while a coefficient calculation component determines the α-dependent weights needed to approximate the resolvent. A resolvent approximation component constructs a compressed representation Mα, which mimics the behavior of the true resolvent with exponential convergence guarantees based on analyticity properties. Finally, an Alpha Centrality computation component calculates the influence scores via matrix-vector multiplication x=Mαβ, and an analysis component interprets these scores, ranks nodes accordingly, and optionally filters results based on a predefined threshold.

By offloading the computationally intensive portion of the analysis to an offline precomputation stage and enabling dynamic updates through the exogenous influence vector, the system provides a scalable, accurate, and efficient approach for influence quantification in complex networks. This enables centrality-driven applications—such as recommendation engines, fraud detection systems, epidemiological modeling, and information dissemination analysis—to operate on large datasets in real-time or near real-time, overcoming the scalability limitations of traditional approaches.

According to an embodiment, a system can comprise a processor that executes computer executable components stored in memory. The computer executable components can comprise a graph construction component that builds an adjacency matrix A from raw network data. The computer executable components can further comprise an exogenous influence component that generates an influence vector β by assigning values that reflect external factors influencing network nodes. The computer executable components can further comprise a parameter control component that establishes key parameters. The computer executable components can further comprise a Chebyshev polynomial generator component that iteratively computes polynomial terms. The computer executable components can further comprise a coefficient calculation component that computes required Chebyshev coefficients αₖ for accurate weighting of each polynomial term. The computer executable components can further comprise a resolvent approximation component that reconstructs inverse-like matrix behavior. The computer executable components can further comprise an Alpha Centrality computation component that calculates node influence scores. The computer executable components can further comprise an analysis component that scales the computed scores and maps them back to node identities.

In some embodiments, the external factors can further comprise scaling factor α and the polynomial approximation degree K. In various embodiments, the analysis component can rank the importance of node i of the network by counting the number of weighted walks in a graph starting at vertex i, while penalizing longer walks with a user-chosen parameter α∈(0,1/∥A∥₂), where ∥A∥₂ is a matrix 2-norm of A.

In some embodiments, the resolvent approximation component can approximate resolvent (I−αA)⁻¹ as

$${( I - α A )}^{- 1} \approx M α = {Σ}_{k = 1}^{K} {ℓ}_{k} ( α ) {( I - {ζ}_{k} A )}^{- 1}$$

and where

$${ℓ}_{k} ( ζ ) = {Π}_{j = 1 , j \neq k}^{K} \frac{ζ - {ζ}_{j}}{{ζ}_{k} - {ζ}_{j}} .$$

The approximation can converge exponentially O(ρ^{-K}), where ρ is an analyticity factor. The resolvent (I−αA)⁻¹ can be applied through an LDLT matrix factorization. In some embodiments, the polynomial terms can approximate the resolvent's behavior.

In various embodiments, the Chebyshev polynomial generator component can iteratively compute polynomial terms using recurrence relation T₀=I, T₁=A, and Tₖ₊₁=2ATₖ−Tₖ₋₁. The Alpha Centrality computation component can calculate node influence scores using equation x=M_{α,1}β. The analysis component can identify the most influential nodes based on Alpha Centrality scores exceeding a predetermined threshold. The graph construction component can be configured to handle weighted edges to account for varying relationship strengths between nodes. In some embodiments, the exogenous influence component can dynamically update the influence vector β in response to real-time data changes.

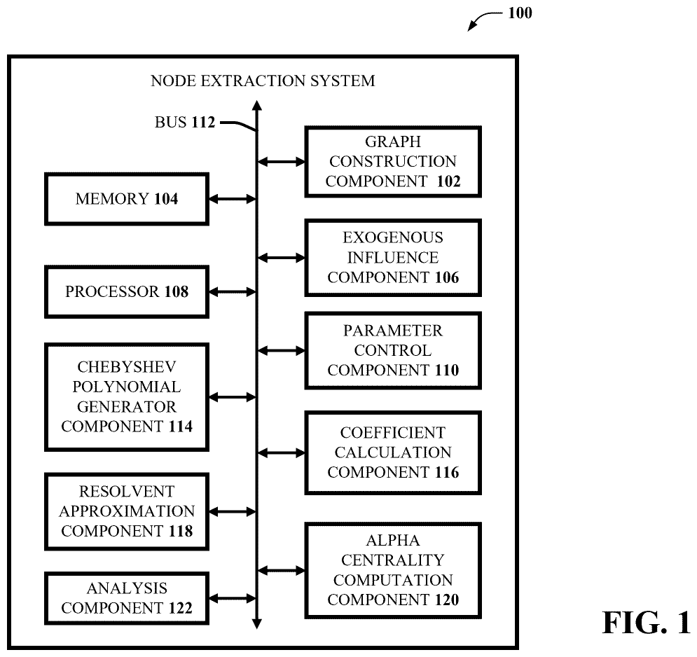

FIG. 1 illustrates an example system 100 for facilitating most important node extraction via Alpha centrality with multiple damping factors. The system 100 uses a graph construction component, an exogenous influence component, a parameter control component, a Chebyshev polynomial generator component, a coefficient calculation component, a resolvent approximation component, an Alpha Centrality computation component, and an analysis component. The graph construction component can build an adjacency matrix A from raw network data. The exogenous influence component can generate an influence vector β by assigning values that reflect external factors influencing network nodes. The parameter control component can establish key parameters. The Chebyshev polynomial generator component can iteratively compute polynomial terms. The coefficient calculation component can compute required Chebyshev coefficients αₖ for accurate weighting of each polynomial term. The resolvent approximation component can reconstruct inverse-like matrix behavior. The Alpha Centrality computation component can calculate node influence scores. The analysis component can scale the computed scores and map them back to node identities.

Aspects of systems (e.g., system 100, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by the one or more machines (e.g., computers, computing devices, virtual machines, etc.) can cause the machines to perform the operations described. System 100 can comprise a graph construction component 102, a memory 104, an exogenous influence component 106, a processor 108, a parameter control component 110, a system bus 112, a Chebyshev polynomial generator component 114, a coefficient calculation component 116, a resolvent approximation component 118, an Alpha Centrality computation component 120, and an analysis component 122.

The system 100 and/or the components of the system 100 may use hardware and/or software to solve problems that are highly technical in nature. The system 100 solves problems that are not abstract and that cannot be performed as a set of mental acts by a human. Further, some of the processes can be performed by specialized computers for carrying out defined tasks related to most important node extraction via Alpha centrality with multiple damping factors. The system 100 and/or components of the system 100 can be employed to solve new problems that arise through advancements in technologies. The system 100 can provide technical improvements to most important node extraction via Alpha centrality with multiple damping factors by employing a Chebyshev-based rational approximation of the resolvent operator that enables efficient, scalable computation of influence scores across a range of a values, thereby reducing the need for repeated linear system solutions and enabling real-time performance on large graphs.

The system 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that may be operably connected to the processor 108. The memory 104 can store computer-executable instructions that, upon execution by the processor 108, can cause the processor 108 and/or one or more other components of the system 100 (e.g., the graph construction component 102, the exogenous influence component 106, the parameter control component 110, the Chebyshev polynomial generator component 114, the coefficient calculation component 116, the resolvent approximation component 118, the Alpha Centrality computation component 120, and/or the analysis component 122) to perform one or more actions. In some embodiments, the memory 104 can store computer-executable components (e.g., the graph construction component 102, the exogenous influence component 106, the parameter control component 110, the Chebyshev polynomial generator component 114, the coefficient calculation component 116, the resolvent approximation component 118, the Alpha Centrality computation component 120, and/or the analysis component 122).

The system 100 and/or a component thereof as described herein can be communicatively, electrically, operatively, optically, and/or otherwise coupled to one another via a bus 112. The bus 112 can include one or more of a memory bus, memory controller, peripheral bus, external bus, local bus, and/or another type of bus that may employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writable, and/or executable components and/or instructions. When executed by the processor 108, these components and/or instructions can enable performance of one or more operations defined by the component(s) and/or instruction(s).

In various embodiments, the graph construction component 102 can build an adjacency matrix A from raw network data. The raw network data can include structured or unstructured information that represents relationships between entities, such as individuals in a social network, accounts in a financial system, or molecules in a biological interaction network. The graph construction component 102 can process this data to identify nodes and their interconnections, and can optionally account for edge weights that reflect the strength, directionality, or frequency of interactions. Based on this processed information, the component 102 can generate an adjacency matrix A, where each entry Aᵢⱼ can correspond to the presence or weighted strength of an edge from node i to node j. The graph construction component 102 can be configured to handle weighted edges, thereby enabling the system 100 to account for varying relationship strengths between nodes in the network. This weighted representation can provide a more nuanced and accurate foundation for downstream computations. The resulting matrix can serve as a foundational structure for performing centrality computations and related graph-based analyses. The adjacency matrix A constructed by the graph construction component 102 can be utilized in downstream computations such as Chebyshev polynomial generation, resolvent approximations, and Alpha Centrality evaluations. In some embodiments, the graph construction component 102 can further support the modeling of dynamic graphs, inclusion of multiple edge types, or integration of additional metadata such as node and edge attributes. This flexibility can enable the system 100 to accurately represent a wide range of real-world networks.

According to some embodiments, the exogenous influence component 106 can generates an influence vector β by assigning values that reflect external factors influencing network nodes. The external factors can further comprise scaling factor α and the polynomial approximation degree K. The exogenous influence component can dynamically update the influence vector β in response to real-time data changes. These external factors can represent domain-specific influences such as user engagement metrics in a social platform, financial risk scores in a trading network, or environmental signals in sensor networks. The exogenous influence component 106 can enable the system 100 to incorporate context-specific data into the centrality analysis, allowing the resulting influence scores to reflect not only the structure of the network but also real-world conditions affecting each node's relative importance. The exogenous influence component 106 can also account for technical parameters such as the scaling factor α, which can control the damping of longer walks in Katz or Alpha Centrality computations, and the polynomial approximation degree K, which can affect the accuracy and convergence rate of the resolvent approximation. These values can be included as part of the external inputs used to construct or refine the influence vector β. In some embodiments, the exogenous influence component 106 can dynamically update β in response to real-time data changes, enabling the system 100 to adapt centrality computations to evolving conditions within the network. This capability can be particularly useful in applications where the underlying network or its contextual parameters change over time, such as live recommendation systems, dynamic risk assessment tools, or adaptive resource allocation engines.

According to some embodiments, the parameter control component 110 can establish key parameters. In various embodiments, the parameter control component 110 can establish key parameters used throughout the influence computation process. These parameters can include, but are not limited to, the scaling factor α, which governs the attenuation of longer walks in Katz or Alpha Centrality computations, and the polynomial approximation degree K, which determines the number of terms used in the Chebyshev or rational polynomial expansion of the resolvent operator. The parameter control component 110 can allow the system 100 to balance computational efficiency with analytical precision by adjusting these values based on the characteristics of the input graph, available computational resources, or desired accuracy thresholds. The parameter control component 110 can also interface with other components of the system 100, such as the exogenous influence component 106 and the Chebyshev polynomial generator component, to ensure that consistent and appropriate parameter values are applied across all stages of the computation pipeline. In some embodiments, the parameter control component 110 can receive user input or operate autonomously based on heuristics or optimization objectives. For instance, it can select an appropriate value of K to guarantee a target approximation error or dynamically adjust a based on the spectral properties of the adjacency matrix A.

In various embodiments, the Chebyshev polynomial generator component 114 can iteratively compute polynomial terms that are used to approximate the behavior of matrix functions involved in influence scoring, such as the resolvent (I−αA)⁻¹. The component 114 can leverage the recurrence relation for Chebyshev polynomials, specifically T₀=I, T₁=A, and Tₖ₊₁=2ATₖ−Tₖ₋₁, where A is the adjacency matrix and/is the identity matrix. This recurrence-based approach can allow the system 100 to efficiently compute higher-order polynomial terms without the need for explicit matrix exponentiation or storage of all intermediate powers of A, thereby reducing computational complexity and memory overhead. The Chebyshev polynomial generator component 114 can work in conjunction with the coefficient calculation component and the parameter control component to ensure that the correct number of polynomial terms are generated based on the user-defined or system-selected approximation degree K. In some embodiments, the component 114 can also support weighted or shifted Chebyshev expansions, enabling more flexible approximations tailored to the spectral properties of the matrix A. By iteratively generating a compact and computationally efficient polynomial basis, the Chebyshev polynomial generator component 114 can provide the mathematical infrastructure needed to construct high-fidelity resolvent approximations and facilitate fast, scalable Alpha Centrality computations.

In some embodiments, the coefficient calculation component 116 can compute required Chebyshev coefficients αₖ for accurate weighting of each polynomial term. The coefficient calculation component 116 can compute the required Chebyshev coefficients αₖ that can provide accurate weighting for each polynomial term in the Chebyshev or rational approximation of the resolvent (I−αA)⁻¹. These coefficients can be derived based on analytical formulations, numerical integration, or interpolation techniques that consider the specific approximation scheme being used—such as Clenshaw-Curtis quadrature or barycentric interpolation over Chebyshev nodes. The computed coefficients αₖ can ensure that the resulting polynomial approximation converges rapidly to the true matrix function, thereby enabling high-accuracy results with a reduced number of terms. The coefficient calculation component 116 can interface with the parameter control component to receive values such as the approximation degree K and the damping factor α, which can influence the distribution and computation of the coefficients. In some embodiments, the component 116 can support real-time coefficient recalculation in response to dynamic changes in system parameters or graph structure, maintaining the fidelity of the approximation across evolving conditions.

In various embodiments, the resolvent approximation component 118 can reconstruct inverse-like matrix behavior. Rather than directly computing the inverse, which can be computationally intensive for large-scale graphs, the resolvent approximation component 118 can approximate the resolvent (I−αA)⁻¹ using a rational function expansion of the form

$${( I - α A )}^{- 1} \approx M α = {Σ}_{k = 1}^{K} {ℓ}_{k} ( α ) {( l - {ζ}_{k} A )}^{- 1} ,$$

where [symbol] are carefully chosen interpolation points and [symbol] (ζ) are Lagrange coefficients defined as

$${ℓ}_{k} ( ζ ) = {Π}_{j = 1 , j \neq k}^{K} \frac{ζ - {ζ}_{j}}{{ζ}_{k} - {ζ}_{j}} .$$

This approach can enable the system 100 to approximate the resolvent operator by combining a small number of shifted matrix inverses, dramatically reducing computational overhead while maintaining high approximation fidelity. The approximation provided by the resolvent approximation component 118 can exhibit exponential convergence on the order of O(ρ^{-K}), where ρ is an analyticity factor that depends on the spectral properties of the adjacency matrix A and the domain of the approximation. In some embodiments, the resolvent component 118 can apply each shifted inverse (I−ζₖA)⁻¹ using efficient numerical techniques, including LDLT matrix factorization, which can further enhance stability and performance. Additionally, the component 118 can operate in conjunction with the Chebyshev polynomial generator component 114 and the coefficient calculation component 116 to ensure the polynomial and rational terms closely mirror the behavior of the true resolvent.

According to some embodiments, the Alpha Centrality computation component 120 can calculate node influence scores. The Alpha Centrality computation component 120 can calculate node influence scores using equation x=M_{α,1}β, where M_{α} represents an approximation of the resolvent (I−αA)⁻¹ and β is an influence vector generated by the exogenous influence component. This formulation allows the system 100 to assess how influence propagates through the network by accounting for both the topology of the graph, captured by the adjacency matrix A, and external pressures or contextual inputs reflected in β. Each entry xi in the resulting vector x can quantify the cumulative influence of node i, considering both direct and indirect interactions, with longer interaction paths attenuated by the parameter α. The Alpha Centrality computation component 120 can integrate seamlessly with the other components of the system 100, including the resolvent approximation component and the coefficient calculation component, to ensure that the influence scores are computed efficiently and with high fidelity. In some embodiments, the component 120 can support dynamic updates to the scores in response to changes in graph structure or external influence inputs, making it suitable for real-time or streaming network environments. By executing this central computation, the Alpha Centrality computation component 120 can provide meaningful, mathematically grounded metrics of node importance that are suitable for use in a wide range of applications, such as recommendation engines, anomaly detection systems, strategic planning tools, and information diffusion models.

In various embodiments, the analysis component 122 can scale the computed scores and map them back to node identities. After the influence vector x is computed, he analysis component 122 can normalize, rescale, or transform these scores as needed for downstream applications, such as visualization, ranking, or classification. This mapping process ensures that the abstract numerical results generated from spectral or polynomial approximations can be meaningfully interpreted in the context of real-world entities represented by the network nodes. The analysis component 122 can also rank the importance of each node i in the network by interpreting the centrality score xi as a measure of the number of weighted walks originating at that node, where longer walks are penalized by a user-defined damping parameter α∈(0,1/∥A∥²), where ∥A∥² is a matrix 2-norm of A. In this way, the analysis component 122 can quantify the reach or influence of each node by aggregating both direct and indirect paths through the network, while systematically attenuating the impact of more distant nodes. In some embodiments, the component 122 can further identify the most influential nodes by selecting those with Alpha Centrality scores that exceed a predefined threshold. This can allow the system 100 to filter high-impact nodes for applications such as key opinion leader detection, fraud hotspot identification, or resource prioritization in dynamic networks.

The systems and/or devices are described herein with respect to interaction between one or more components. Such systems and/or components may include the components and/or sub-components specified therein, one or more of the specified components and/or sub-components, and/or additional components. Sub-components may be implemented as components communicatively coupled to other components rather than included within parent components. One or more components and/or sub-components may be combined into a single component providing aggregate functionality. The components may interact with one or more other components not specifically described herein for the sake of brevity but known by those of skill in the art.

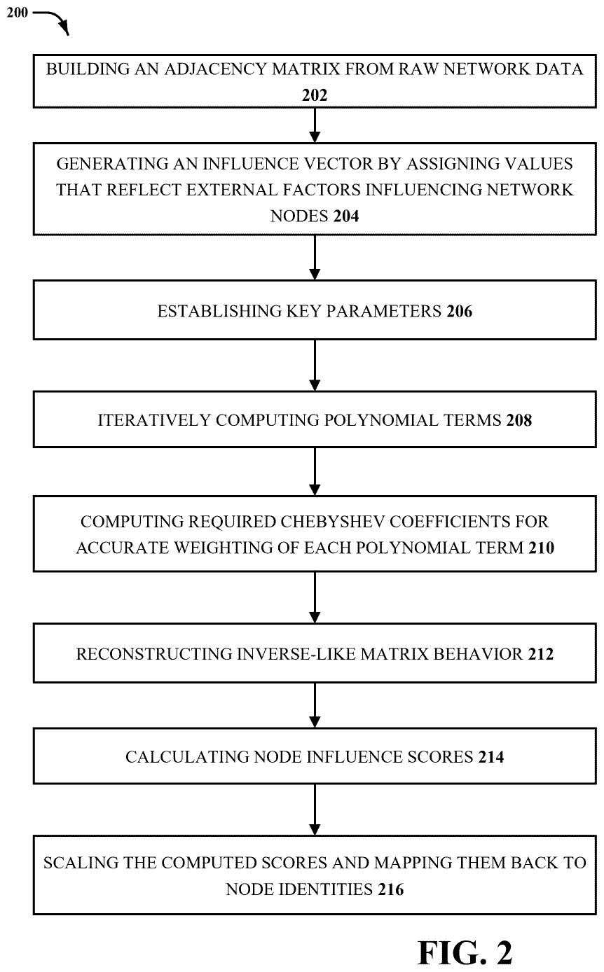

FIG. 2 illustrates an example a flow diagram of a computer implemented method that can facilitate most important node extraction via Alpha centrality with multiple damping factors in accordance with some embodiments described herein.

The flow diagram 200 starts by building 202 an adjacency matrix from raw network data. At block 202, the method can include building an adjacency matrix from raw network data. This step can involve processing input data that describes relationships or interactions among entities within a domain-specific network. The raw data can originate from various sources, such as logs of user interactions, financial transactions, citation records, sensor readings, or communication exchanges, and can be structured or unstructured. The method can identify nodes representing entities (e.g., individuals, devices, accounts, or records) and edges representing interactions or relationships between those entities. he adjacency matrix can be constructed such that each matrix entry Aᵢⱼ represents the presence or absence of an edge between node i and node j, or the weight of the relationship between them if weighted edges are used. The method can handle directed or undirected graphs and can account for varying relationship strengths by assigning weights to the edges based on factors such as frequency, magnitude, recency, or domain-specific scoring functions. In some embodiments, the method can support normalization of edge weights or filtering of insignificant edges to produce a sparse or thresholded matrix. This adjacency matrix can serve as the foundational representation of the network structure and can be used in subsequent stages of centrality computation, such as influence modeling, polynomial approximation, and resolvent construction.

At block 204, the method 200 can include generating an influence vector by assigning values that reflect external factors influencing network nodes. This influence vector, denoted as β, can capture context-specific signals that modify or enrich the centrality analysis by incorporating exogenous data not encoded in the structural topology of the graph. The method can assign values to each element of β based on external factors such as user engagement scores, financial indicators, geographic activity levels, or predefined risk assessments, depending on the application domain. The influence vector β can be used in conjunction with the adjacency matrix to drive personalized or context-sensitive Alpha Centrality computations. In some embodiments, the method can dynamically update the vector β to reflect changes in the underlying data—such as evolving user behaviors, shifting network conditions, or streaming updates—enabling real-time responsiveness. Additionally, this step can include setting technical parameters such as the damping factor α and the approximation degree K, which govern the weight decay over longer walks and the fidelity of the polynomial approximation, respectively. By encoding external influence alongside structural relationships, the method 200 can enable richer and more adaptive computation of node importance scores.

At block 206, the method 200 can include establishing key parameters used throughout the influence computation process. These parameters can include, but are not limited to, the scaling factor α, which can govern the attenuation of longer walks in Katz or Alpha Centrality computations, and the polynomial approximation degree K, which can determine the number of terms used in the Chebyshev or rational polynomial expansion of the resolvent operator. Establishing key parameters 206 can balance computational efficiency with analytical precision by adjusting these values based on the characteristics of the input graph, available computational resources, or desired accuracy thresholds. Establishing key parameters can further ensure that consistent and appropriate parameter values are applied across all stages of the computation pipeline. In some embodiments, block 206 can include receiving user input or operating based on heuristics or optimization objectives. For instance, 206 can include selecting an appropriate value of K to guarantee a target approximation error or dynamically adjusting a based on the spectral properties of the adjacency matrix A.

At block 208, the method 200 can include iteratively computing polynomial terms. The polynomial terms can be used to approximate the behavior of matrix functions involved in influence scoring, such as the resolvent (I−αA)⁻¹. Act 208 van further include leveraging the recurrence relation for Chebyshev polynomials, specifically T₀=I, T₁=A, and Tₖ₊₁=2ATₖ−Tₖ₋₁, where A is the adjacency matrix and/is the identity matrix. This recurrence-based approach can allow for efficient computation of higher-order polynomial terms without the need for explicit matrix exponentiation or storage of all intermediate powers of A, thereby reducing computational complexity and/or memory overhead. Act 208 can ensure that the correct number of polynomial terms are generated based on the user-defined or system-selected approximation degree K. In some embodiments, the act 208 can support weighted or shifted Chebyshev expansions, enabling more flexible approximations tailored to the spectral properties of the matrix A. By iteratively generating a compact and computationally efficient polynomial basis, act 208 can provide the mathematical infrastructure needed to construct high-fidelity resolvent approximations and facilitate fast, scalable Alpha Centrality computations.

At block 210, the method 200 can include computing required Chebyshev coefficients for accurate weighing of each polynomial term. Act 210 can include computing the required Chebyshev coefficients αₖ that can provide accurate weighting for each polynomial term in the Chebyshev or rational approximation of the resolvent (I−αA)⁻¹. These coefficients can be derived based on analytical formulations, numerical integration, or interpolation techniques that consider the specific approximation scheme being used—such as Clenshaw-Curtis quadrature or barycentric interpolation over Chebyshev nodes. The computed coefficients αₖ can ensure that the resulting polynomial approximation converges rapidly to the true matrix function, thereby enabling high-accuracy results with a reduced number of terms. Act 210 can include receiving values such as the approximation degree K and the damping factor, which can influence the distribution and computation of the coefficients. In some embodiments, act 210 can support real-time coefficient recalculation in response to dynamic changes in system parameters or graph structure, maintaining the fidelity of the approximation across evolving conditions.

At block 212, the method 200 can include reconstructing inverse-like matrix behavior. Rather than directly computing the inverse, which can be computationally intensive for large-scale graphs, the act 212 can include approximating the resolvent (I−αA)⁻¹ using a rational function expansion of the form

$${( I - α A )}^{- 1} \approx M α = {Σ}_{k = 1}^{K} {ℓ}_{k} ( α ) {( I - {ζ}_{k} A )}^{- 1} ,$$

where [symbol] are carefully chosen interpolation points and [symbol] (ζ) are Lagrange coefficients defined as

$${ℓ}_{k} ( ζ ) = {Π}_{j = 1 , j \neq k}^{K} \frac{ζ - {ζ}_{j}}{{ζ}_{k} - {ζ}_{j}} .$$

This approach can enable approximation of the resolvent operator by combining a small number of shifted matrix inverses, dramatically reducing computational overhead while maintaining high approximation fidelity. The approximation provided by the act 212 can exhibit exponential convergence on the order of O(ρ^{-K}), where ρ is an analyticity factor that depends on the spectral properties of the adjacency matrix A and the domain of the approximation. In some embodiments, act 212 can include applying each shifted inverse (I−ζₖA)⁻¹ using efficient numerical techniques, including LDLT matrix factorization, which can further enhance stability and performance. Additionally, act 212 can ensure the polynomial and rational terms closely mirror the behavior of the true resolvent.

At block 214, the method 200 can include calculating node influence scores. The node influence scores can be calculated using equation x=M_{α,1}β, where M_{α} represents an approximation of the resolvent (I−αA)⁻¹ and β is an influence vector. This formulation allows for an assessment of how influence propagates through the network by accounting for both the topology of the graph, captured by the adjacency matrix A, and external pressures or contextual inputs reflected in β. Each entry xᵢ in the resulting vector x can quantify the cumulative influence of node i, considering both direct and indirect interactions, with longer interaction paths attenuated by the parameter α. Act 214 can ensure that the influence scores are computed efficiently and with high fidelity. In some embodiments, act 214 can include dynamically updating the scores in response to changes in graph structure or external influence inputs, making it suitable for real-time or streaming network environments. By executing this central computation, act 214 can provide meaningful, mathematically grounded metrics of node importance that are suitable for use in a wide range of applications, such as recommendation engines, anomaly detection systems, strategic planning tools, and information diffusion models.

At block 216, the method 200 can include scaling the computed scores and mapping them back to node identities. After the influence vector x is computed, these scores can be normalized, rescaled, or transformed as needed for downstream applications, such as visualization, ranking, or classification. This mapping process can ensure that the abstract numerical results generated from spectral or polynomial approximations can be meaningfully interpreted in the context of real-world entities represented by the network nodes. Act 216 can further include ranking the importance of each node i in the network by interpreting the centrality score xᵢ as a measure of the number of weighted walks originating at that node, where longer walks are penalized by a user-defined damping parameter α∈(0,1/∥A∥₂), where ∥A∥₂ is a matrix 2-norm of A. In this way, act 216 can quantify the reach or influence of each node by aggregating both direct and indirect paths through the network, while systematically attenuating the impact of more distant nodes. In some embodiments, act 216 can further include identifying the most influential nodes by selecting those with Alpha Centrality scores that exceed a predefined threshold. This can allow for filtering of high-impact nodes for applications such as key opinion leader detection, fraud hotspot identification, or resource prioritization in dynamic networks.

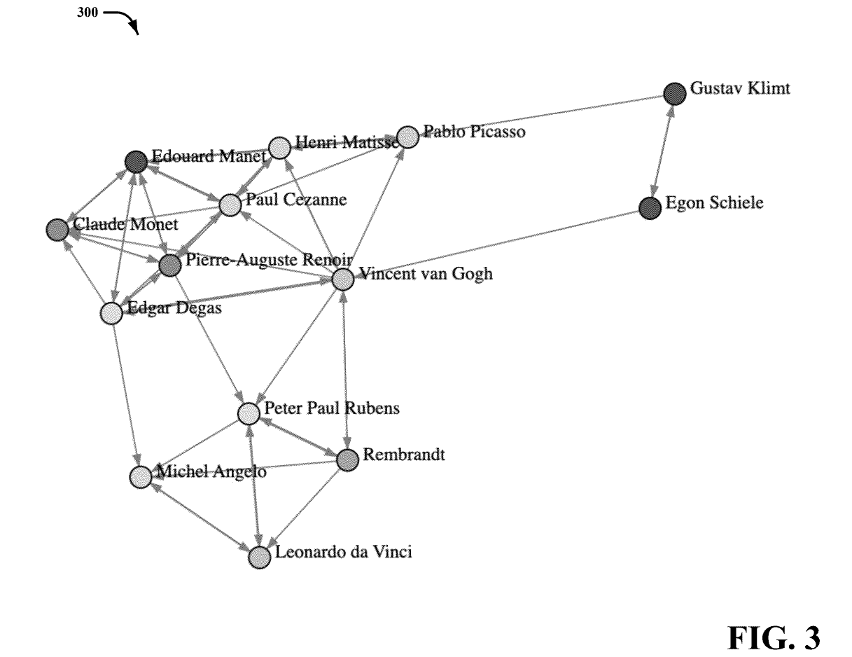

Next, FIG. 3 illustrates an example of a graph structure 300 used to represent influence relationships in accordance with some embodiments described herein. The example graph structure 300 can represent influence relationships among historical painters. Each node can represent a painter, and each directed edge can denote an influence from one painter to another. The varying node colors and sizes can correspond to a centrality measure—such as Katz centrality—which can indicate the relative influence of each painter within the network. As it relates to the solution described herein, this example graph 300 can serve as a visualization of how centrality metrics are applied in real-world network analysis. Specifically, Katz centrality could be used in FIG. 3 to quantify how influential a painter is—not just by direct followers (immediate connections) but also through longer paths of artistic influence, with diminishing weight for more distant connections. This can require computing weighted walks through the graph for each painter, which can be computationally expensive when repeated for many values of the attenuation factor α. The solution described herein addresses the need for efficient computation of such centrality metrics at scale, making analyses like the one illustrated in FIG. 3 feasible for much larger or more dynamic networks.

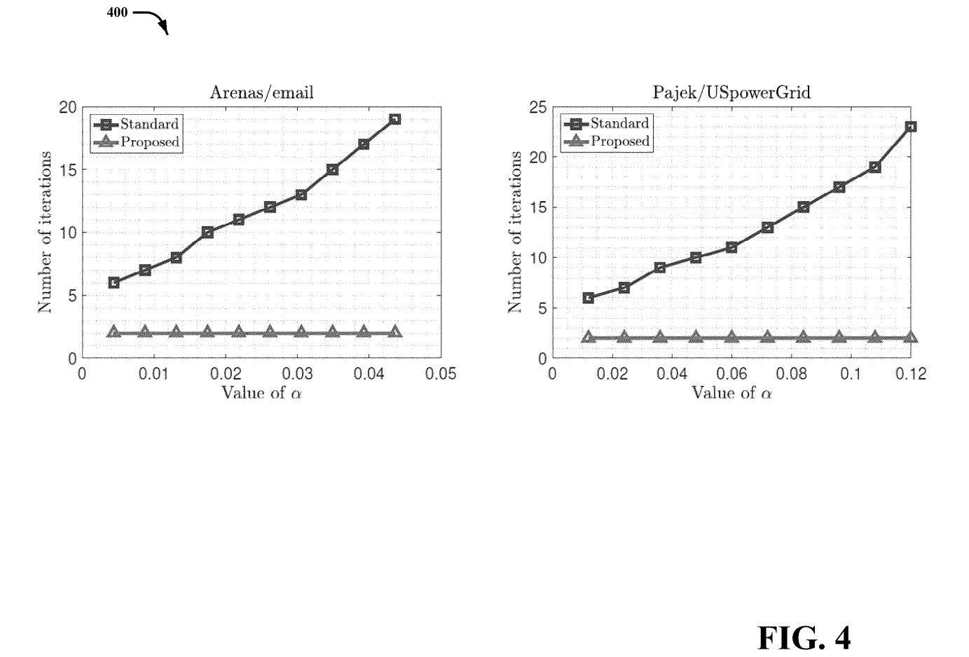

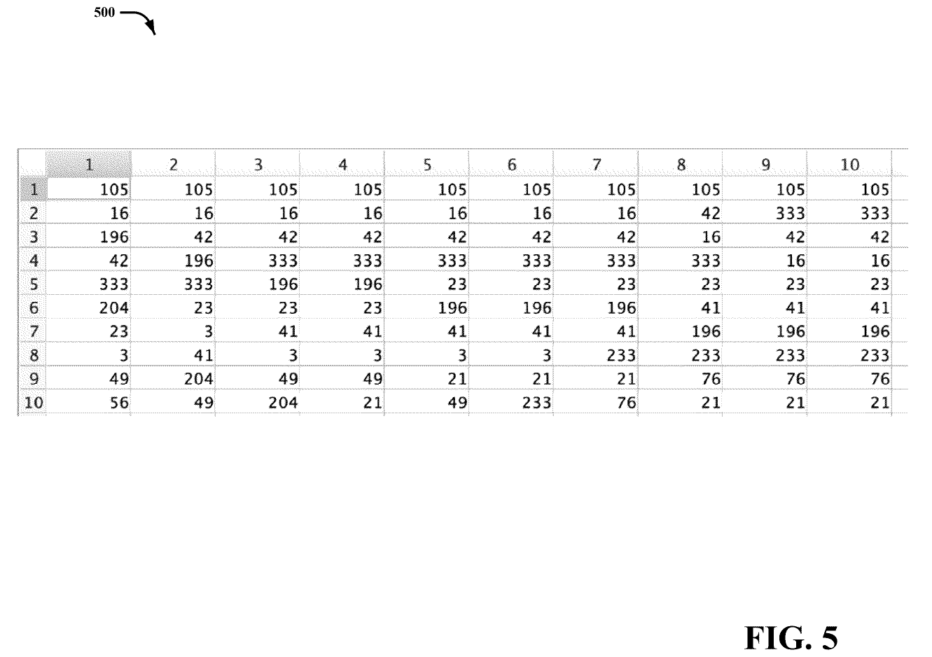

Next, FIGS. 4 and 5 illustrate results of an example use case demonstrating the effectiveness of most important node extraction via Alpha centrality with multiple damping factors in accordance with some embodiments described herein.

FIG. 4 shows results from a first numerical experiment comparing the performance of a standard MINRES solver with a proposed approach that uses M_{α} as a preconditioner. The left chart presents results on the Arenas/email dataset, while the right chart corresponds to a dataset. In both cases, the standard solver exhibits a significant increase in the number of iterations required as the value of a increases. This trend reflects the increasing difficulty of solving linear systems that approach singularity as a nears 1/∥A∥₂. In contrast, the proposed method using M_{α} maintains a nearly constant and minimal number of iterations across all values of α, demonstrating that the preconditioner can enable efficient and stable convergence. This experiment can illustrate that the disclosed method can significantly reduce computational burden while preserving accuracy, making it highly scalable for use in large networks.

FIG. 5 presents results from a second numerical experiment that explores how the top-10 most influential nodes in a network change as the damping factor α varies. Each column in the table corresponds to a different a value, and each row indicates the ranked node IDs based on their Alpha Centrality scores. This experiment can demonstrate that certain nodes, such as node 105 and node 16, consistently appear at the top of the rankings across α values, indicating stable influence. However, the positions of other nodes shift noticeably as α changes, reflecting the sensitivity of Katz centrality to the weighting of longer walks. This variability highlights the value of computing influence across multiple α values and supports the ability of the disclosed solution to enable robust multi-scale analysis. The herein described systems and methods can thus provide a nuanced view of influence that adapts to the underlying dynamics of the network.

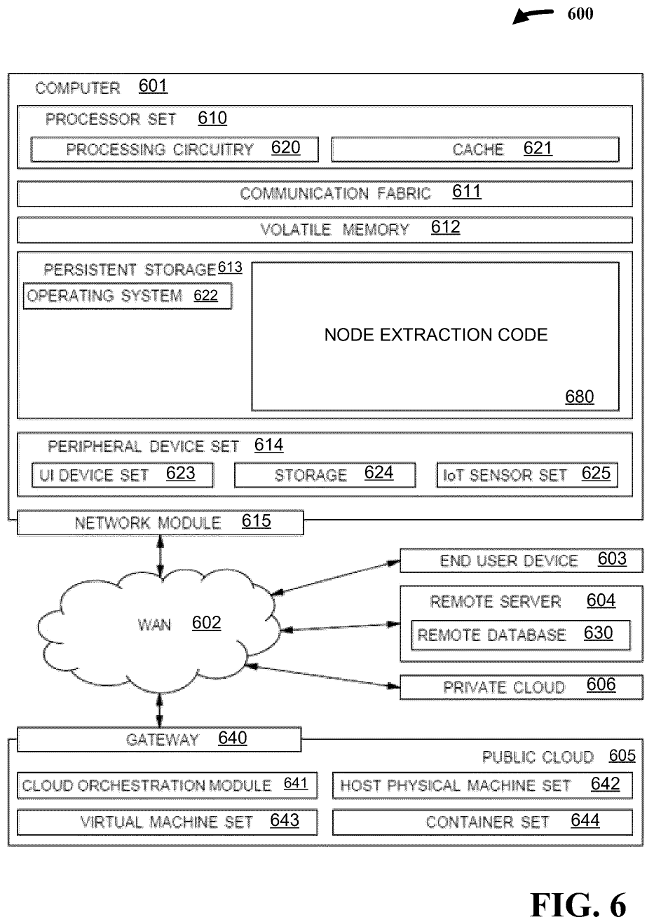

Next, FIG. 6 and the following discussion are intended to provide a brief, general description of a suitable computing environment 600 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code involved in performing the inventive methods, such as iteratively updating the preliminary recovery plan until a failure-free recovery plan is developed with knowledge distillation code 680. In addition to block 680, computing environment 600 includes, for example, computer 601, wide area network (WAN) 602, end user device (EUD) 603, remote server 604, public cloud 605, and private cloud 606. In this embodiment, computer 601 includes processor set 614 (including processing circuitry 620 and cache 621), communication fabric 611, volatile memory 612, persistent storage 613 (including operating system 622 and block 645, as identified above), peripheral device set 614 (including user interface (UI), device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method can be distributed among multiple computers and/or between multiple locations. On the other hand, in this presentation of computing environment 600, detailed discussion is focused on a single computer, specifically computer 601, to keep the presentation as simple as possible. Computer 601 can be located in a cloud, even though it is not shown in a cloud in FIG. 6. On the other hand, computer 601 is not required to be in a cloud except to any extent as can be affirmatively indicated.

PROCESSOR SET 610 includes one, or more, computer processors of any type now known or to be developed in the future. Processing circuitry 620 can be distributed over multiple packages, for example, multiple, coordinated integrated circuit chips. Processing circuitry 620 can implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set can be located “off chip.” In some computing environments, processor set 610 can be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods can be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths and/or wireless communication paths.

VOLATILE MEMORY 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory can be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 can be a read only memory (ROM), but typically at least a portion of the persistent storage allows writing of data, deletion of data and re-writing of data. Some familiar forms of persistent storage include magnetic disks and solid-state storage devices. Operating system 622 can take several forms, such as various known proprietary operating systems or open-source Portable Operating System Interface type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 can include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 can be persistent and/or volatile. In some embodiments, storage 624 can take the form of a quantum computing storage device for storing data in the form of qubits. In embodiments where computer 601 is required to have a large amount of storage (for example, where computer 601 locally stores and manages a large database) then this storage can be provided by peripheral storage devices designed for storing large amounts of data, such as a storage area network (SAN) that is shared by multiple, geographically distributed computers. IoT sensor set 625 is made up of sensors that can be used in Internet of Things applications. For example, one sensor can be a thermometer, and another sensor can be a motion detector.

NETWORK MODULE 615 is the collection of computer software, hardware, and firmware that allows computer 601 to communicate with other computers through WAN 602. Network module 615 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601) and can take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 can be a client device, such as thin client, heavy client, mainframe computer and/or desktop computer.

REMOTE SERVER 604 is any computer system that serves at least some data and/or functionality to computer 601. Remote server 604 can be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data can be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs can be stored as images and can be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware and firmware allowing public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 675 and private cloud 676 are both part of a larger hybrid cloud. The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of some of the embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to some embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a graph construction component that builds an adjacency matrix A from raw network data;
an exogenous influence component that generates an influence vector β by assigning values that reflect external factors influencing network nodes;
a parameter control component that establishes key parameters;
a Chebyshev polynomial generator component that iteratively computes polynomial terms;
a coefficient calculation component that computes required Chebyshev coefficients αₖ for accurate weighting of each polynomial term;
a resolvent approximation component that reconstructs inverse-like matrix behavior;
an Alpha Centrality computation component that calculates node influence scores; and
an analysis component that scales the computed scores and maps them back to node identities.

2. The system of claim 1, wherein the external factors further comprise scaling factor α and polynomial approximation degree K.

3. The system of claim 1, wherein the analysis component ranks an importance of node i of the network by counting a number of weighted walks in a graph starting at vertex i, while penalizing longer walks with a user-chosen parameter α∈(0,1/∥A∥₂), where ∥A∥₂ is a matrix 2-norm of A.

4. The system of claim 1, wherein resolvent approximation component approximates resolvent (I−αA)⁻¹ as
$${( I - α A )}^{- 1} \approx M α = {Σ}_{k = 1}^{K} {ℓ}_{k} ( α ) {( I - {ζ}_{k} A )}^{- 1}$$
and where
$${ℓ}_{k} ( ζ ) = {Π}_{j = 1 , j \neq k}^{K} \frac{ζ - {ζ}_{j}}{{ζ}_{k} - {ζ}_{j}} .$$

5. The system of claim 4, wherein the approximation of the resolvent by the approximation component converges exponentially O(ρ^{-K}), where ρ is an analyticity factor.

6. The system of claim 5, wherein resolvent (I−αA)⁻¹ is applied through an LDLT matrix factorization.

7. The system of claim 4, wherein the polynomial terms approximate the resolvent's behavior.

8. The system of claim 1, wherein the Chebyshev polynomial generator component iteratively computes polynomial terms using recurrence relation T₀=I, T₁=A, and Tₖ₊₁=2ATₖ−Tₖ₋₁.

9. The system of claim 1, wherein the Alpha Centrality computation component calculates node influence scores using equation x=M_{α,1}β.

10. The system of claim 1, wherein the analysis component identifies most influential nodes based on Alpha Centrality scores exceeding a predetermined threshold.

11. The system of claim 1, wherein the graph construction component is configured to handle weighted edges to account for varying relationship strengths between nodes.

12. The system of claim 1, wherein the exogenous influence component dynamically updates the influence vector β in response to real-time data changes.

13. A computer-implemented method that utilizes a processor that executes computer executable components stored in memory to perform the following acts:
building an adjacency matrix A from raw network data;
generating an influence vector β by assigning values that reflect external factors influencing network nodes;
establishing key parameters;
iteratively computing polynomial terms;
computing required Chebyshev coefficients αₖ for accurate weighting of each polynomial term;
reconstructing inverse-like matrix behavior;
calculating node influence scores; and
scaling the computed scores and mapping them back to node identities.

14. The method of claim 13, wherein the external factors further comprise scaling factor α and polynomial approximation degree K.

15. The method of claim 13, further comprising ranking an importance of node i of the network by counting a number of weighted walks in a graph starting at vertex i, while penalizing longer walks with a user-chosen parameter α∈(0,1/∥A∥₂), where ∥A∥₂ is a matrix 2-norm of A.

16. The method of claim 13, further comprising approximating resolvent (I−αA)⁻¹ as
$${( I - α A )}^{- 1} \approx M α = {Σ}_{k = 1}^{K} {ℓ}_{k} ( α ) {( I - {ζ}_{k} A )}^{- 1}$$
and where
$${ℓ}_{k} ( ζ ) = {Π}_{j = 1 , j \neq k}^{K} \frac{ζ - {ζ}_{j}}{{ζ}_{k} - {ζ}_{j}} .$$

17. The method of claim 16, wherein the approximating the resolvent converges exponentially O(ρ^{-K}), where ρ is an analyticity factor.

18. The method of claim 13, further comprising applying resolvent (I−αA)⁻¹ through an LDLT matrix factorization.

19. The method of claim 13, further comprising calculating node influence scores using equation x=M_{α,1}β.

20. A computer program product comprising a computer readable storage medium having program instructions embodied therewith, the program instructions executable by a processor to cause the processor to:
generate an influence vector β by assigning values that reflect external factors influencing network nodes;
establish key parameters;
iteratively compute polynomial terms;
compute required Chebyshev coefficients αₖ for accurate weighting of each polynomial term;
reconstruct inverse-like matrix behavior;
calculate node influence scores; and
scale the computed scores and map them back to node identities.
